(19) United States
(12) Patent Application Publication
(10) Pub. No.: US 2015/0034275 A1
(43) Pub. Date: Feb. 5, 2015

(54) HEAT EXCHANGING SYSTEM OF VENDING MACHINE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: XU LI, Wuhan (CN); YONG-CHANG FAN, Wuhan (CN); LI-FU XU, Wuhan (CN)

(21) Appl. No.: 14/451,841

(22) Filed: Aug. 5, 2014

(30) Foreign Application Priority Data
Aug. 5, 2013 (CN) 2013103350144

(51) Int. Cl. G07F 17/00

(52) U.S. Cl. CPC G07F 17/0078
USPC 165/59

(57) ABSTRACT

A heat exchanging system is disclosed. The heat exchanging system includes an evaporator configured for cooling an electronic device, a heater configured for heating an electronic device, and a fan located between the evaporator and the heater. When the evaporator is operated to cool air, the heater is stopped, and the cooled air flows in the electronic device under an action of the fan to cool the electronic device. When the heater is operated to heat air, the evaporator is stopped, and the heated air flows in the electronic device under the action of the fan to heat the electronic device.

### FIELD

Embodiments of the present disclosure relate to vending machines, and particularly to a heat exchanging system in a vending machine.

### BACKGROUND

A vending machine generally includes a refrigeration area and a heating area, and a four-way valve is used for exchanging heating and refrigerating. A refrigeration structure is mounted in the refrigeration area, and a heating structure is mounted in the heating area.

### BRIEF DESCRIPTION OF THE DRAWINGS

Many aspects of the embodiments herein can be better understood with reference to the following drawings. The components in the drawings are not necessarily drawn to scale, the emphasis instead being placed upon clearly illustrating the principles of the embodiments. Like reference numerals designate corresponding parts throughout the several views of the drawings.

FIG. 1 is an exploded, isometric view of one embodiment of a heat exchanging system in a vending machine.

FIG. 2 is similar to FIG. 1, but viewed from a different angle.

FIG. 3 is an assembled, isometric view of the heat exchanging system of FIG. 1.

FIG. 4 is similar to FIG. 3, showing an air duct is partially cut.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

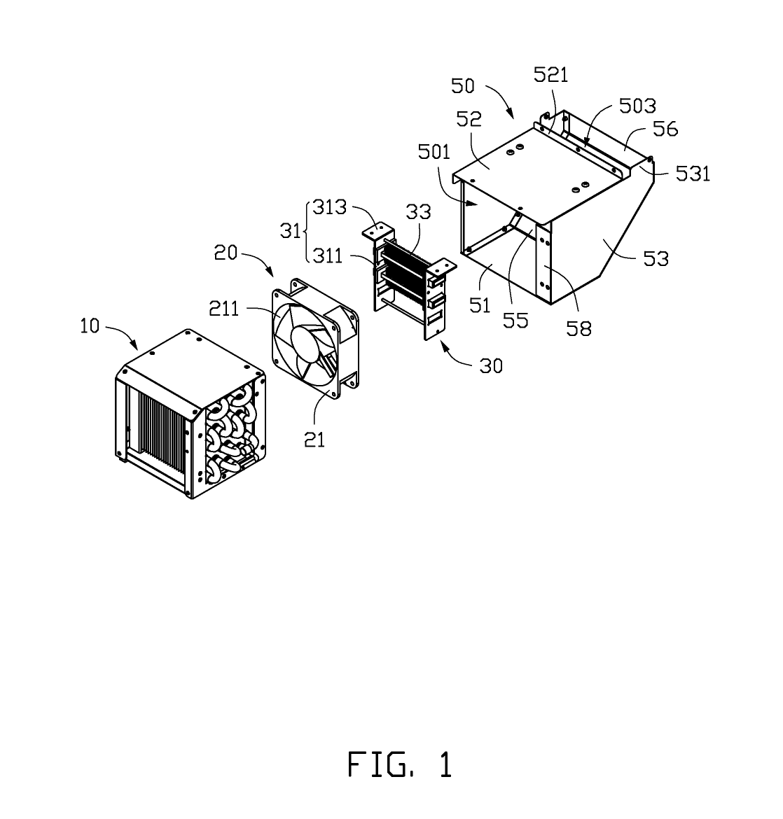

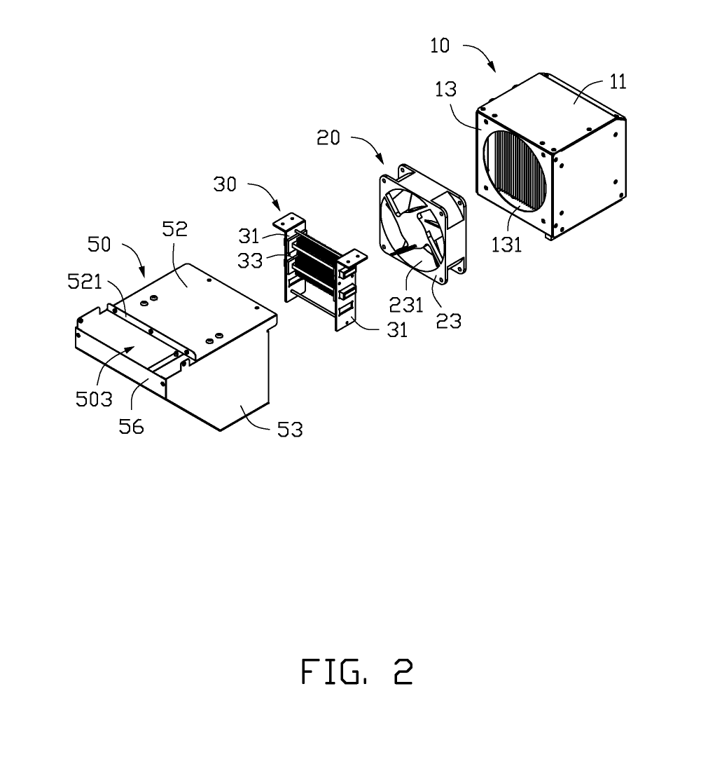

FIG. 1 and FIG. 2 illustrate one embodiment of a heat exchanging system. The heat exchanging system can include an evaporator 10, a fan 20, a heater 30, and an air duct 50.

The evaporator 10 includes a rear cover 13 and a top cover 11. The rear cover 13 defines an opening 131. In one embodiment, the rear cover 13 is substantially perpendicular to the top cover 11, and the opening 131 is circular. The evaporator 10 is configured for cooling an electronic device, such as a vending machine.

The fan 20 includes a front plate 21 and a rear plate 23 opposite to the front plate 21. The rear plate 23 is substantially parallel to the front plate 21. The front plate 21 defines an air inlet 211. The rear plate 23 defines an air outlet 231. In one embodiment, a size of the air inlet 211 is substantially equal to a size of the opening 131. In the illustrated embodiment, the fan 20 can be an axial fan.

The heater 30 can include two frames 31 and a plurality of heating sheets 33 secured between the two frames 31. Each frame 31 includes an installation piece 311 and a mounting piece 313 perpendicularly connected to the installation piece 311. The two mounting pieces 313 of the two frames 31 extend in two opposite directions. In one embodiment, the two installation pieces 311 are substantially parallel to each other. The heating sheets 33 are secured between the two installation pieces 311.

The air duct 30 can include a bottom wall 51, a top wall 52, two opposite sidewalls 53, a first guiding plate 55, and a second guiding plate 56. The first guiding plate 55 slantingly connects the bottom wall 51 and the second guiding plate 56. In one embodiment, the bottom wall 51 is substantially parallel to the top wall 52 and is substantially perpendicular to each sidewall 53, the second guiding plate 56 is substantially perpendicular to the bottom wall 51, an obtuse angle is defined between the first guiding plate 55 and the bottom wall 51, and an obtuse angle is defined between the first guiding plate 55 and the second guiding plate 56. The top wall 52 extends out of the two sidewalls 53 and the bottom wall 51. A first locking piece 58 is perpendicularly connected to the bottom wall 51 and one of the two sidewalls 53. The bottom wall 51, the top wall 52, and the two sidewalls 53 cooperatively define a guiding inlet 501. A side edge of the top wall 52, each top edge of the two sidewalls 53, and a top edge of the second guiding plate 56 cooperatively define a guiding outlet 503. A second locking piece 521 extends upwards from the side edge of top wall 52. A third locking piece 531 extends upwards from a top edge of each sidewall 53. The first locking piece 58, the second locking piece 521, and the third locking piece 531 are configured for cooperatively securing the air duct 50 in the electronic device.

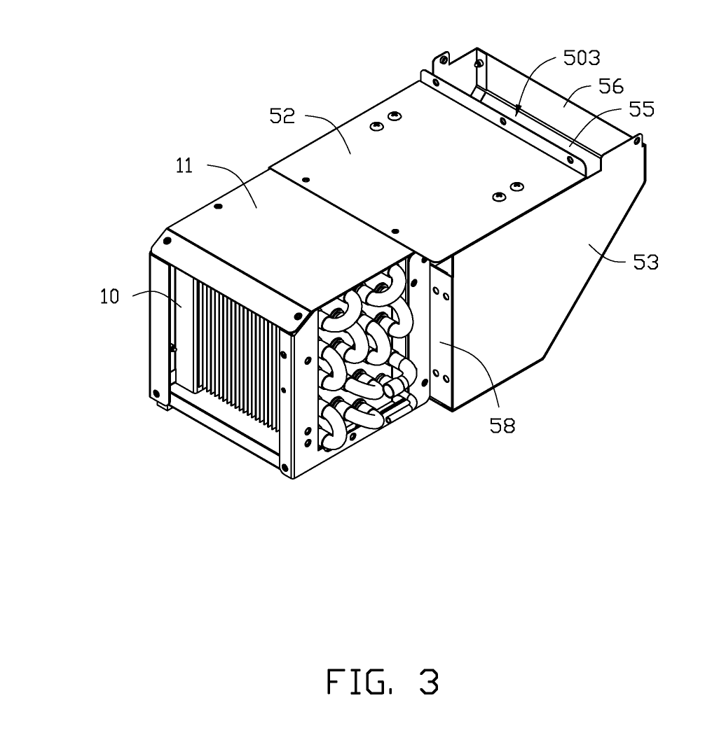

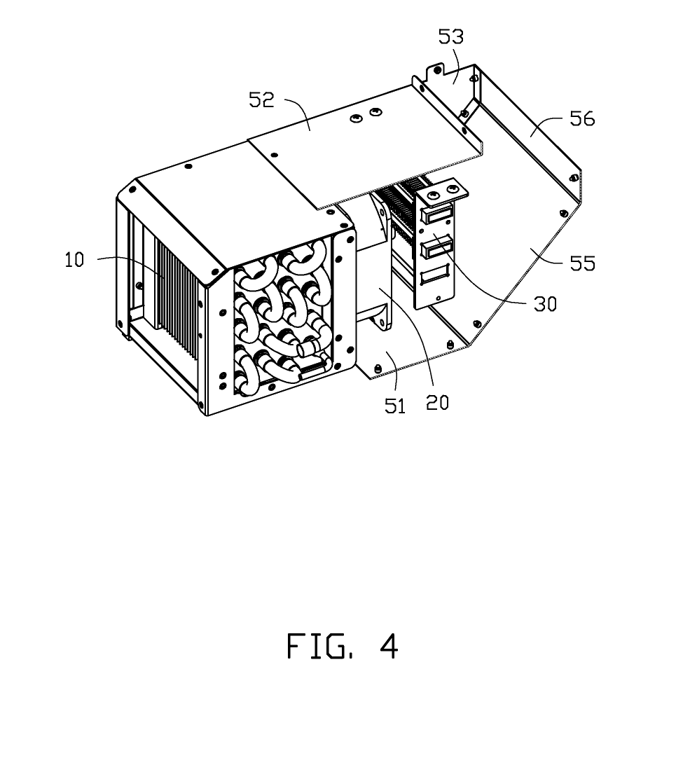

FIG. 3 and FIG. 4 illustrate that when the heat exchanging system is in an assembled configuration, the fan 20 is moved towards the evaporator 10 to abut the front plate 21 to the rear cover 13 with the opening 131 aligned with the air inlet 211. The front plate 21 is secured to the rear cover 13 by screws or other methods. The heater 30 is placed in the air duct 50, and the mounting pieces 313 are secured to the top wall 52. The air duct 50 is moved towards the evaporator 10 and the fan 20 is received in the air duct 50. The portion of the top wall 52, which extends out of the sidewall 53 and the bottom wall 51, abuts and is secured to the top cover 11. The fan 20 is located between the rear cover 13 and the heater 30. The air outlet 231 faces the heater 30.

In use, air flows into the guiding inlet 501 via the evaporator 10, the air outlet 231, and the heater 30 under an action of the fan 20 and flows out of the guiding outlet 503 under a guiding of the first guiding plate 55 and the second guiding plate 56. When cooling, the evaporator 10 is operated, the heater 30 is stopped, and cool air generated from the evaporator 10 flows into the electronic device via the fan 20, the heater 30, and the guiding outlet 503 under drafting of the fan 20. When heating, the evaporator 10 is stopped, the heater 30 is operated, and hot air flows into the electronic device via the fan 20, the heater 30, and the guiding outlet 503 under blowing of the fan 20.

In another embodiment, placements of the evaporator 10 and the heater 30 can be exchanged, that is the air outlet 231 faces to the evaporator 10, and the air inlet 211 faces to the heater 30.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and the arrangement of parts within the principles of the disclosure. The embodiments discussed herein do not limit the following claims.

What is claimed is:

1. A heat exchanging system comprising:
an evaporator configured for cooling an electronic device;
a heater configured for heating an electronic device; and
a fan located between the evaporator and the heater;
wherein when the evaporator is operated to cool air, the heater is stopped, and the cooled air flows in the electronic device under an action of the fan; and when the heater is operated to heat air, the evaporator is stopped, and the heated air flows in the electronic device under the action of the fan.

2. The heat exchanging system of claim 1, further comprising an air duct defining a guiding inlet and a guiding outlet, wherein the fan and the heater are located in the air duct, the fan and the heater are located in a side of the guiding inlet, and the cooled air and the heated air flow into the electronic device via the guiding outlet.

3. The heat exchanging system of claim 2, wherein the fan comprises a front plate defining an air inlet, the evaporator includes a rear cover defining an opening, the font plate abuts the rear cover, and the air inlet is aligned with the opening.

4. The heat exchanging system of claim 3, wherein a size of the air outlet is substantially equal to a size of the opening.

5. The heat exchanging system of claim 3, wherein the fan further comprises a rear plate substantially parallel to the front plate, the rear plate defines an air outlet, and the air outlet faces to the heater.

6. The heat exchanging system of claim 2, wherein when the evaporator is operated to cool air, the fan drafts the cooled air to flow to the guiding outlet via the fan, the heater, and the air duct; and when the heater is operated to heat air, the fan blows the heated air to flow to the guiding outlet via the heater and the air duct.

7. The heat exchanging system of claim 2, wherein the air duct comprises a top wall, a bottom wall, two sidewalls, a first guiding plate, and a second guiding plate, the heater is secured to the top wall, the top wall, the bottom wall, and the two sidewalls cooperatively define the guiding inlet, the first guiding plate is connected to the second guiding plate and the bottom wall, and the top wall, the two sidewalls, and the second guiding plate cooperatively define the guiding outlet.

8. The heat exchanging system of claim 7, wherein the second guiding plate is substantially perpendicular to the bottom wall, and the first guiding plate is slantingly connected to the bottom wall and the second guiding plate.

9. The heat exchanging system of claim 7, wherein the evaporator further comprises a top cover, a portion of the top wall extends out of the bottom wall and the two sidewalls, and the portion of the top wall abuts and is secured to the top cover.

10. The heat exchanging system of claim 7, wherein air duct further comprises a locking piece perpendicularly connected to the bottom wall and one of the two sidewalls, the locking piece covers a gap defined between the evaporator and the guiding inlet and is configured for securing the air duct to an object.

11. A heat exchanging system comprising:
an evaporator configured for cooling an electronic device;
a heater configured for heating an electronic device; and
a fan located between the evaporator and the heater;
wherein when the evaporator is operated to cool air, the heater is stopped, a first air path is defined by the evaporator, the fan, the heater, and the electronic device under inspiring of the fan; and when the heater is operated to heat air, the evaporator is stopped, and a second air path is defined by the heater and the electronic device under blowing of the fan.

12. The heat exchanging system of claim 11, further comprising an air duct defining a guiding inlet and a guiding outlet, wherein the fan and the heater are located in the air duct, the fan and the heater are located in a side of the guiding inlet, and the cooled air and the heated air flow into the electronic device via the guiding outlet.

13. The heat exchanging system of claim 12, wherein the fan comprises a front plate defining an air inlet, the evaporator includes a rear cover defining an opening, the font plate abuts the rear cover, and the air inlet is aligned with the opening.

14. The heat exchanging system of claim 13, wherein a size of the air outlet is substantially equal to a size of the opening.

15. The heat exchanging system of claim 13, wherein the fan further comprises a rear plate substantially parallel to the front plate, the rear plate defines an air outlet, and the air outlet faces to the heater.

16. The heat exchanging system of claim 12, wherein when the evaporator is operated to cool air, the fan drafts the cooled air to flow to the guiding outlet via the fan, the heater, and the air duct; and when the heater is operated to heat air, the fan blows the heated air to flow to the guiding outlet via the heater and the air duct.

17. The heat exchanging system of claim 12, wherein the air duct comprises a top wall, a bottom wall, two sidewalls, a first guiding plate, and a second guiding plate, the heater is secured to the top wall, the top wall, the bottom wall, and the two sidewalls cooperatively define the guiding inlet, the first guiding plate is connected to the second guiding plate and the bottom wall, and the top wall, the two sidewalls, and the second guiding plate cooperatively define the guiding outlet.

18. The heat exchanging system of claim 17, wherein the second guiding plate is substantially perpendicular to the bottom wall, and the first guiding plate is slantingly connected to the bottom wall and the second guiding plate.

19. The heat exchanging system of claim 17, wherein the evaporator further comprises a top cover, a portion of the top wall extends out of the bottom wall and the two sidewalls, and the portion of the top wall abuts and is secured to the top cover.

20. The heat exchanging system of claim 17, wherein air duct further comprises a locking piece perpendicularly connected to the bottom wall and one of the two sidewalls, the locking piece covers a gap defined between the evaporator and the guiding inlet and is configured for securing the air duct to an object.
